(19) United States
(12) Patent Application Publication
(10) Pub. No.: US 2006/0077887 A1
(43) Pub. Date: Apr. 13, 2006

(54) Data transmission method in multiband orthogonal frequency division multiplexing (OFDM) system

(75) Inventors: Jae-ho Roh, Seoul (KR); Jae-hyun Koo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/247,246

(22) Filed: Oct. 12, 2005

Related U.S. Application Data
(60) Provisional application No. 60/617,667, filed on Oct. 13, 2004.

(30) Foreign Application Priority Data
Apr. 28, 2005 (KR) 2005-35600

(51) Int. Cl. H04J 11/00

(52) U.S. Cl. 370/208

(57) ABSTRACT

A method is provided for reducing error occurring when a receiving end of a multiband OFDM system estimates original data from the received data. The multiband OFDM system, which transmits data using at last two radio resources, maps the data to at least two mapping data among a plurality of mapping data not to overlap each other and transmits the mapped data at least two times.

### CROSS-REFERENCE TO RELATED APPLICATIONS

This application claims priority from U.S. Provisional Patent Application No. 60/617,667 filed on Oct. 13, 2004 in the United States Patent and Trademark Office, and Korean Patent Application No. 2005-35600 filed on Apr. 28, 2005 in the Korean Intellectual Property Office, the entire disclosures of which are incorporated herein by reference.

### BACKGROUND OF THE INVENTION

1. Field of the Invention

Methods consistent with the present invention relates generally to multiband orthogonal frequency division (OFDM), and more particularly, effectively transmitting symbols in an OFDM system using a plurality of sub-bands.

2. Description of the Related Art

An OFDM system converts incoming serial symbols to parallel symbols with a certain size, and multiplexes and transmits the converted parallel symbols at different frequencies that are orthogonal to each other.

A multiband OFDM system transmits OFDM symbols by hopping (frequency hopping) a plurality of frequency bands by symbols. For instance, multiband OFDM is adopted as the modulation mechanism for specific wireless communication systems such as ultra wideband (UWB) systems. Multiband OFDM modulation combines OFDM modulation with the frequency hopping technique. Hereinafter, the multiband OFDM system applied to the UWB is explained first. The multiband OFDM system divides the total bandwidth into a plurality of sub-bands with certain frequency bands. The multiband OFDM system transmits data (symbols) through the plurality of sub-bands, and thus transmits and receives more data within a fixed time. The UWB system selects one of the plurality of sub-bands and uses the selected sub-band according to a prescribed regulation. Accordingly, data security can be enhanced.

FIG. 1 illustrates a plurality of sub-bands to be used in a multiband OFDM system suggested at present. As shown in FIG. 1, the frequency band of the multiband OFDM system has a center frequency ranging from 3432 MHz to 10296 MHz. Primarily, the frequency band of the multiband OFDM system consists of five groups, i.e., first through fifth groups. The first through fourth groups include three sub-bands, and the fifth group includes two sub-bands.

Center frequencies of the three sub-bands in the first group are 3432 MHz, 3960 MHz, and 4488 MHz. and center frequencies of the three sub-bands in the second group are 5016 MHz, 5544 MHz, and 6072 MHz. Center frequencies of the three sub-bands in the third group are 6600 MHz, 7128 MHz, and 7656 MHz, and center frequencies of the sub-bands in the fourth group are 8184 MHz, 8712 MHz, and 9240 MHz. Center frequencies of the two sub-bands in the fifth group are 9768 MHz and 10296 MHz.

Table 1 shows payload transmissions depending on a data rate in the multiband OFDM system.

TABLE 1

| Data rate | | | | | Spreading |
|---|---|---|---|---|---|
| (Mbps) | Modulation | Coding rate | Conjugation | TSF | gain |
| 53.3 | QPSK | 1/3 | yes | 2 | 4 |
| 55 | QPSK | 11/32 | yes | 2 | 4 |
| 80 | QPSK | 1/2 | yes | 2 | 4 |
| 106.67 | QPSK | 1/3 | no | 2 | 2 |
| 110 | QPSK | 11/32 | no | 2 | 2 |
| 160 | QPSK | 1/2 | no | 2 | 2 |
| 200 | QPSK | 5/8 | no | 2 | 2 |
| 320 | DCM | 1/2 | no | 1 | 1 |
| 400 | DCM | 5/8 | no | 1 | 1 |
| 480 | DCM | 3/4 | no | 1 | 1 |

The Multiband OFDM system employs the quadrature phase shift keying (QPSK) method for the data rate between 53.3 Mbps and 200 Mbps, and the dual carrier modulation (DCM) method for the data rate between 320 Mbps and 480 Mbps.

When the multiband OFDM system transmits conjugate symbols at the data rate from 53.3 Mbps to 80 Mbps, the spreading gain is 4. That is, at the data rate between 53.3 Mbps and 80 Mbps, one symbol is transmitted together with its conjugate symbol four times in total since the time spreading factor (TSF) is 2.

Table 2 shows the symbol transmissions in the multiband OFDM system at the data rate of 53.3 Mbps, 55 Mbps, and 80 Mbps.

TABLE 2

| Data | Mapping data |
|---|---|
| D0 | C0 |
| D1 | C1 |
| . | . |
| . | . |
| . | . |
| D49 | C49 |
| D49* | C50 |
| . | . |
| . | . |
| . | . |
| D1* | C98 |
| D0* | C99 |

According to Table 1, each data is transmitted twice, including its conjugate data. Specifically, a transmitting end transmits data D0 through D49 together with its conjugate data D0* through D49*.

Typically, according to the QPSK modulation method, the transmitting end transmits one data by dividing the data into a real component and an imaginary component. Meanwhile, if the original data and the conjugate data are input to an inverse fast Fourier transformer (IFFT), the IFFT outputs the real component alone. In this case, the transmitting end requires a construction only for the real component.

As such, when the transmitting end transmits only the real component, a receiving end needs to estimate the original data using only the real component. As compared to the data estimation using both the real component and the imaginary component, the data estimation using the real component increases data error.

In addition, when the transmitting end transmits only the real component, a resolution of the signal from the transmitting end deteriorates, as compared to the signal resolution having both the real component and the imaginary component.

### SUMMARY OF THE INVENTION

An aspect of the present invention provides a method for reducing computations executed to transmit data at a transmitting end in a multiband OFDM system.

Another aspect of the present invention provides a method for reducing error when a receiving end estimates original data from received data in a multiband OFDM system.

Still another aspect of the present invention provides a method for improving a resolution of a signal transmitted from a transmitting end in a multiband OFDM system.

According to an aspect of the present invention, there is provided a data transmission method in a multiband OFDM system that transmits data using at least two radio resources, includes mapping the data to at least two mapping data among a plurality of mapping data not to overlap each other; and transmitting the mapped data at least two times.

A data rate of the data may be below 100 Mbps. The data may be modulated according to a quadrature phase shift keying (QPSK) scheme.

The data and the mapping data may be one of (C0, C99), (C1, C98), . . . , (C48, C51), (C49, C50) when the mapping data are consecutively arranged from C0 to C99.

### BRIEF DESCRIPTION OF THE DRAWING FIGURES

The above and/or other aspects of the invention will become apparent and more readily appreciated from the following description of exemplary embodiments, taken in conjunction with the accompanying drawing figures of which:

FIG. 1 illustrates a frequency band used by a multiband OFDM system; and

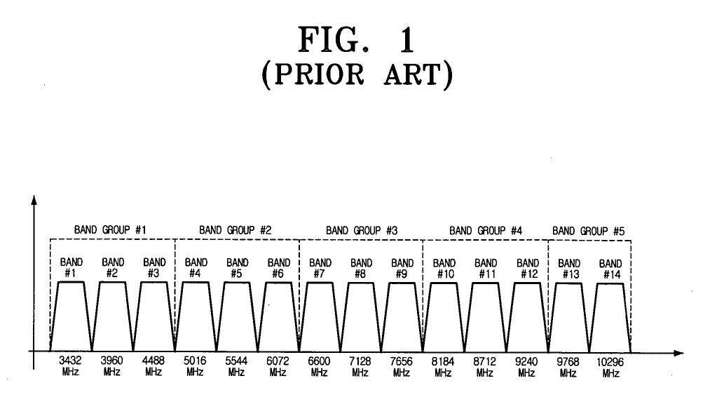

FIG. 2 is a block diagram of a transmitting end of a multiband OFDM system according to an embodiment of the present invention.

### DETAILED DESCRIPTION OF THE EXEMPLARY EMBODIMENTS

Certain exemplary embodiments of the present invention will now be described in greater detail with reference to the accompanying drawings. According to an exemplary embodiment of the present invention, a transmitting end of a multiband OFDM system transmits only original data regardless of a data rate.

Table 3 shows schemes for transmitting a payload and a pilot depending on a data rate in the multiband OFDM system according to an exemplary embodiment of the present invention.

TABLE 3

| Data rate | | | | | Spreading |
|---|---|---|---|---|---|
| (Mbps) | Modulation | Coding rate | Conjugation | TSF | gain |
| 53.3 | QPSK | 1/3 | no | 2 | 4 |
| 55 | QPSK | 11/32 | no | 2 | 4 |
| 80 | QPSK | 1/2 | no | 2 | 4 |
| 106.67 | QPSK | 1/3 | no | 2 | 2 |
| 110 | QPSK | 11/32 | no | 2 | 2 |
| 160 | QPSK | 1/2 | no | 2 | 2 |
| 200 | QPSK | 5/8 | no | 2 | 2 |
| 320 | DCM | 1/2 | no | 1 | 1 |
| 400 | DCM | 5/8 | no | 1 | 1 |
| 480 | DCM | 3/4 | no | 1 | 1 |

The multiband OFDM system adopts the quadrature phase shift keying (QPSK) scheme at the data rate ranging from 53.3 Mbps to 200 Mbps, and the dual carrier modulation scheme at the data rate ranging from 320 Mbps to 480 Mbps.

According to an exemplary embodiment of the present invention, the multiband OFDM system does not transmit conjugate symbols regardless of the data rate. In particular, the multiband OFDM system, unlike the conventional system, transmits data by mapping the data to two different data without transmitting the conjugate data. For instance, at the data rate of 53.3 Mbps, 55 Mbps, and 80 Mbps, the multiband OFDM system has the spreading gain of 4 since the TSF is 2. Also, each OFDM symbol includes 100 encoded bits.

Table 4 shows symbol transmissions of the multiband OFDM system according to an exemplary embodiment of the present invention.

TABLE 4

| Data | Mapping data |
|---|---|
| D0 | C0 |
| D1 | C1 |
| . | . |
| . | . |
| . | . |
| D49 | C49 |
| D49 | C50 |
| . | . |
| . | . |
| . | . |
| D1 | C98 |
| D0 | C99 |

In Table 4, the transmitting end transmits same data two times, without conjugate data. For instance, the transmitting end transmits data D0 by mapping the data D0 to C0 and C99, and transmits data D1 by mapping the data D1 to C1 and C98. Thus, the transmitting end can transmit one data which is divided into a real component and an imaginary component.

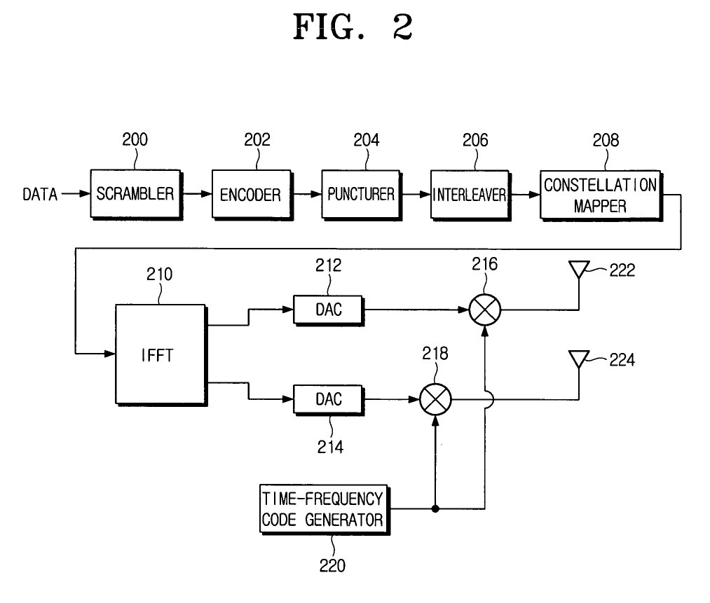

FIG. 2 illustrates a construction of the transmitting end according to an exemplary embodiment of the present invention, which is described in detail.

The transmitting end includes a scrambler 200, an encoder 202, a puncturer 204, an interleaver 206, a constellation mapper 208, an IFFT 210, digital-to-analog converters (DACs) 212 and 214, multipliers 216 and 218, a time-frequency code generator 220, and antennas 222 and 224.

The scrambler 200 receives data. The transmitting end, which stores Table 4, provides the scrambler 200 with mapping data corresponding to the data to be transmitted. Note that a receiving end of the multiband OFDM system also stores Table 4.

The scrambler 200 scrambles the provided data and transfers the scrambled data to the encoder 202. The encoder 202 encodes the scrambled data. The encoder 202 conducts the encoding using codes such as convolution code, Reed-Solomon code, Low Density Parity Check (LDPC) code, and Turbo code. The coding rate of the encoder 202 is shown in Table 4.

The puncturer 204 receives from the encoder 202 and punctures the encoded symbols. Thus, the transmitting end can reduce the number of the symbols to be transmitted.

The interleaver 206 interleaves bits of the symbols received from the puncturer 204. Thus, the receiving end can correct error generated on a radio channel. In other words, the interleaving at the transmitting end enables the multiband OFDM system to prevent block error.

The constellation mapper 208 modulates the received symbols according to the modulation schemes corresponding to the data rates. The constellation mapper 208 modulates the symbols using constellation corresponding to the modulation schemes.

The IFFT 210 inserts a pilot into the received symbols, and adds a cyclic prefix (CP) and a guard interval (GI) to the symbols. The GI is appended between successive blocks to avoid the symbol interruption. The CP is appended to address a problem that orthogonality between the received symbols is not maintained due to the latency. The IFFT 210 conducts the inverse fast Fourier transform operation on the received symbols. Unlike the related art, the conjugate data is not transmitted according to an exemplary embodiment of the present invention. Hence, the IFFT 210 outputs a real component and an imaginary component at the same time.

The DAC 212 converts a digital signal corresponding to the provided real component to an analog signal. The DAC 214 converts a digital signal corresponding to the imaginary component to an analog signal. The time-frequency code generator 220 generates a time-frequency code to obtain effects of time diversity and frequency diversity.

The generated time-frequency code is provided to the multipliers 216 and 218. The multiplier 216 multiplies the received analog signal by the time-frequency code and transfers the multiplied signal to the antenna 222. The multiplier 218 multiplies the received analog signal by the time-frequency code and transfers the multiplied signal to the antenna 224.

The antenna 222 and the antenna 224 transmit the signal from the multiplier 216 and the multiplier 218, respectively, to the receiving end via a radio channel. The construction of the receiving end is reverse to that of the transmitting end, and thus not illustrated for brevity.

As set forth above, as the conjugate data is not transmitted regardless of the data rate, the IFFT outputs the real component and the imaginary component with respect to the received data. The transmitting end represents the data using the real component and the imaginary component, and the received end estimates the data by receiving the imaginary component and the real component. Therefore, the error of the estimated data can be reduced.

Furthermore, the construction of the transmitting end can be simplified by eliminating the necessity of elements for computing the conjugate data with respect to the original data.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A data transmission method in a multiband orthogonal frequency division multiplexing (OFDM) system that transmits data using at least two radio resources, the method comprising:
mapping the data to at least two mapping data, among a plurality of mapping data, which do not to overlap each other; and
transmitting the mapped data at least two times.

2. The data transmission method of claim 1, wherein a data rate of the data is below 100 Mbps.

3. The data transmission method of claim 2, wherein the data is modulated according to a quadrature phase shift keying (QPSK) scheme.

4. The data transmission method of claim 2, wherein a spreading gain of the data is 4.

5. The data transmission method of claim 2, wherein the data includes a payload and a pilot.

6. The data transmission method of claim 1, wherein the data and the mapping data is one of (C0, C99), (C 1, C98), . . . , (C48, C51), (C49, C50) where the mapping data are consecutively arranged from C0 to C99.
